(19) United States
(12) Patent Application Publication
(10) Pub. No.: US 2016/0269644 A1
(43) Pub. Date: Sep. 15, 2016

(54) DRIVER FOR ACTUATOR AND CAMERA MODULE AND METHOD THEREOF

(71) Applicant: Samsung Electro-Mechanics Co., Ltd., Suwon-si (KR)

(72) Inventor: Shin Young CHEONG, Suwon-si (KR)

(73) Assignee: Samsung Electro-Mechanics Co., Ltd., Suwon-si (KR)

(21) Appl. No.: 15/067,681

(22) Filed: Mar. 11, 2016

(30) Foreign Application Priority Data
Mar. 13, 2015 (KR) 10-2015-0035265
Sep. 18, 2015 (KR) 10-2015-0132664
Mar. 3, 2016 (KR) 10-2016-0025572

(51) Int. Cl. H04N 5/232; G02B 7/02; G02B 27/64; G02B 7/09

(52) U.S. Cl. CPC H04N 5/23287; G02B 7/09; G02B 7/028; G02B 27/646; H04N 5/23258; H04N 5/23212

(57) ABSTRACT

A driver includes a position detector, a controller, a current applying unit, and a driver actuator. The position detector is configured to detect a position of a lens module. The controller is configured to control movement of the lens module based on information on a target position of the lens module included in an input signal and speed information generated based on the position of the lens module detected by the position detector. The current applying unit is configured to apply a current to move the lens module according to a control of the controller. The driver actuator is configured to drive the lens module according to the current from the current applying unit.

### CROSS-REFERENCE TO RELATED APPLICATION

This application claims the priorities and benefits under 35 USC 119(a) of Korean Patent Application Nos. 10-2015-0035265 filed on Mar. 13, 2015, 10-2015-0132664 filed on Sep. 18, 2015 and 10-2016-0025572 filed on Mar. 3, 2016 with the Korean Intellectual Property Office, the disclosure of which is incorporated herein by reference.

### BACKGROUND

1. Field

The following description relates to a driver for an actuator, a camera module, and a method thereof.

2. Description of Related Art

Presently, most mobile communications terminals include a camera module. The camera module has an auto focusing (AF) function or an image stabilization function that automatically adjusts the focus of a subject.

Auto focusing (AF) refers to positioning a lens at a position to produce a best definition of object of which an image is being captured, among lens positions by moving the lens within a movable range of the lens included in the camera module. Image stabilization refers to stabilizing the capture of the image of the object while a user is hand-shaking the mobile communications terminal at the time of acquiring the image and includes optical image stabilization (OIS), electronic image stabilization (EIS), or other stabilization circuitry and processes.

In order to move the lens, an actuator, such as a voice coil motor, is provided and auto focusing (AF) or image stabilization is performed by controlling the actuator.

In a case in which auto focusing (AF) or image stabilization is performed by using only position information of the lens, it is difficult to reduce time necessary for auto focusing (AF) or image stabilization as much as is desired and, as a result, there is a limit to improving response speed.

Further, in a case in which only one controller is used to control the actuator, there is also a problem in that control performance is changed due to various factors caused during a process of moving the lens.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an embodiment, there is provided a driver, including: a position detector configured to detect a position of a lens module; a controller configured to control movement of the lens module based on information on a target position of the lens module included in an input signal and speed information generated based on the position of the lens module detected by the position detector; a current applying unit configured to apply a current to move the lens module according to a control of the controller; and a driver actuator configured to drive the lens module according to the current from the current applying unit.

The controller may be further configured to generate a first control signal based on the information on the target position, generate a second control signal based on the speed information, and control the current generated in response to the first control signal, or the first control signal and the second control signal.

The controller may include a position controller configured to generate the first control signal according to the information on the target position; a speed detector configured to detect movement speed of the lens module using the position detected by the position detector and generate the speed information; a speed controller configured to generate the second control signal according to the first control signal and the speed information; and a current controller configured to control the current generated based on the second control signal.

The controller may include a position controller configured to generate the first control signal according to the information on the target position; a speed detector configured to detect movement speed of the lens module using the position detected and generate the speed information; a speed controller configured to generate the second control signal according to the speed information; and a current controller configured to control an amount of the current generated based on the first control signal and the second control signal.

In accordance with another embodiment, there is provided a driver, including: controllers having different control characteristics to control a lens module; and a selector configured to select one of the controllers to control the movement of the lens module based on information about a target position of the lens module included in an input signal, and speed information generated based on a position of the lens module.

The selector may select one of the controllers based on one of a target position of the lens module, an attitude of a camera module, and an internal temperature of the camera module.

The selector may select one of the controllers based on one of a distance of movement up to the target position of the lens module, a difference of a distance between a previous position of the lens module and the target position thereof, an accumulated value of error between the target position of the lens module and an actual position thereof, the attitude of the camera module, and the internal temperature of the camera module.

The selector may set a hold flag to prevent a switching of the selection from a currently selected controller to another controller.

The driver may also include a current applying unit configured to apply a current to move the lens module based on a control of the one of the controllers; a driver configured to receive the current to drive the lens module; and a position detector configured to detect the position of the lens module.

The controller may generate a first control signal based on the information on the target position, generates a second control signal based on the speed information, and control the current generated by the current applying unit in response to the first control signal or the first control signal and the second control signal.

The controller may include a position controller configured to generate the first control signal according to the information on the target position; a speed detector configured to detect movement speed of the lens module using the detected position and generate the speed information; a speed controller configured to generate the second control signal based on the first control signal and the speed information; and a current controller configured to control an amount of the current generated based on the second control signal.

The controller may include a position controller configured to generate the first control signal based on the information on the target position; a speed detector configured to detect movement speed of the lens module using the position of the lens module and generate the speed information; a speed controller configured to generate the second control signal based on the speed information; and a current controller configured to control an amount of the current generated by the current applying unit based on the first control signal and the second control signal.

In accordance with a further embodiment, there is provided a camera module, including: an actuator configured to move a lens module; and a driver configured to generate a current to drive the actuator based on information on a target position of the lens module included in an input signal and speed information generated based on a detected position of the lens module.

The driver for an actuator may include a controller configured to control a movement of the lens module based on the information on the target position and the speed information; a current applying unit configured to apply a current to move the lens module based on the control from the controller; and a position detector configured to detect a position of the lens module.

The controller may be configured to generate a first control signal based on the information on the target position, generate a second control signal based on the speed information, and control the current generated by the current applying unit in response to the first control signal or the first control signal and the second control signal.

The controller may include a position controller configured to generate the first control signal according to the information on the target position; a speed detector configured to detect movement speed of the lens module using the detected position and generate the speed information; a speed controller configured to generate the second control signal based on the first control signal and the speed information; and a current controller configured to control an amount of the current generated based on the second control signal.

The controller may include a position controller configured to generate the first control signal according to the information on the target position; a speed detector configured to detect a movement speed of the lens module using the detected position and generate the speed information; a speed controller configured to generate the second control signal according to the speed information; and a current controller to control an amount of the current generated based on the first control signal and the second control signal.

The driver for an actuator may include controllers having different control characteristics of a lens module; and a selector configured to select one of the controllers to control a movement of the lens module based on information about a target position of the lens module included in an input signal, and speed information generated based on a detected position of the lens module.

The selector may select one of the controllers based on one of a target position of the lens module, an attitude of a camera module, and an internal temperature of the camera module.

The selector may select one of the controllers based on one of a distance of movement up to the target position of the lens module, a difference of a distance between a previous position of the lens module and the target position thereof, an accumulated value of error between the target position of the lens module and an actual position thereof, the attitude of the camera module, and the internal temperature of the camera module.

The selector may set a hold flag to prevent a switching of the selection from a currently selected controller to another controller.

The actuator may include a coil configured to generate a magnetic field according to the current; and a magnetic body configured to interact with the magnetic field to generate a driving force moving the lens module.

The camera module may also include a magnetic body configured to detect a strength of the magnetic field, and includes a first magnetic body and a second magnetic body, which are polarized.

The camera module may also include a substrate onto which the driver for the actuator is mounted, wherein the actuator includes a coil disposed on the substrate and configured to generate a magnetic field according to the current; and a magnetic body disposed to face the coil and configured to interact with the current of the coil to generate a driving force moving the lens module.

Magnetic bodies may be disposed in accord with an arrangement of the coil.

The camera module may also include an elastic member disposed on at least one of an upper portion or a lower portion of the lens module to support movement of the lens module.

The camera module may also include a suspension wire configured to transfer the current from the driver for an actuator to the coil.

The actuator may include a first actuator configured to perform an auto focusing (AF) function; and a second actuator configured to perform an optical image stabilization (OIS) function.

The lens module may include at least one of a first frame, a second frame, and a third frame which support an appearance body thereof, and each of the first and second actuators may include a coil and a magnetic body.

The first actuator may further include a first substrate onto which the coil is disposed, and the magnetic body of the first actuator may be disposed on one of one surface or a corner of a first frame.

The second actuator may include an X axis coil mounted on an inner surface of a second substrate having a shape of C to move a lens barrel of the lens module in one direction perpendicular to an optical axis; and a Y axis coil mounted on the inner surface of the second substrate to move the lens barrel of the lens module in another direction that is perpendicular to the optical axis and is horizontal to the one direction.

The second actuator may include two X axis coils, each disposed on two surfaces opposite to each other of the inner surface of the second substrate.

The camera module may also include ball bearings smoothly moving the lens module along an optical axis direction and a direction perpendicular to the optical axis, wherein each of the ball bearings is disposed on at least three corners of a first frame or a second frame.

In accordance with an embodiment, there is provided a driver, including: a position controller configured to define a distance that a lens module is to move based on a target position of the lens module and a current position of the lens module, and output a first control signal indicative thereof; a speed controller configured to receive the first control signal and a current moving speed of the lens module to set a target speed to move the lens module to the target position, and output a second control signal indicative thereof; a current controller configured to set a current based on the second control signal; and a current applying unit configured to apply the current to an actuator to move the lens module up to the target position.

The target speed may be based on a time to complete a movement of the lens module and the distance that the lens module is to move.

The driver may also include a position detector configured to detect the current position of the lens module, and transmit the current position of the lens module to the position controller and the speed detector.

The driver may also include a speed detector configured to calculate the current moving speed of the lens module based on information regarding the current position of the lens module, and transmit the calculated current speed of the lens module to the speed controller.

In accordance with an embodiment, there is provided a method for a driver, including: defining, at a position controller, a distance that a lens module is to move based on a target position of the lens module and a current position of the lens module, and output a first control signal indicative thereof; receiving, at a speed controller, the first control signal and a current moving speed of the lens module to set a target speed to move the lens module to the target position, and output a second control signal indicative thereof; setting, at a current controller, a current based on the second control signal; and applying, at a current applying unit, the current to an actuator to move the lens module up to the target position.

The method may also include controlling an amount of the current based on the first control signal and the second control signal.

The method may also include generating a magnetic field according to the current; and generating a driving force to move the lens module based on the magnetic field.

The method may also include calculating the current speed of the lens module based on information regarding the current position of the lens module.

Other features and aspects will be apparent from the following detailed description, the drawings, and the claims.

### BRIEF DESCRIPTION OF DRAWINGS

These and/or other aspects will become apparent and more readily appreciated from the following description of the embodiments, taken in conjunction with the accompanying drawings in which:

FIG. 1 is an exploded perspective view of a camera module, according to a first embodiment;

FIG. 2 is an exploded perspective view of a camera module, according to a second embodiment;

FIG. 3 is an exploded perspective view of a camera module, according to a third embodiment;

FIG. 4 is a coupled perspective view of the camera module according to each of first through third embodiments illustrated in FIGS. 1 through 3;

FIG. 5 is a block diagram of a driver for an actuator, according to a first embodiment;

FIG. 6 is a block diagram of a driver for an actuator, according to a second embodiment;

FIG. 7 is a block diagram of a driver for an actuator, according to a third embodiment;

FIG. 8 is an operation flow chart of the driver for the actuator, according to the third embodiment illustrated in FIG. 7;

FIGS. 9A through 9E are tables illustrating a controller selection depending on parameters of the driver for the actuator, according to the third embodiment;

FIG. 10A is a graph illustrating a controller output signal and a lens position of a general driver for an actuator, according to the third embodiment; and

FIG. 10B is a graph illustrating a controller output signal and a lens position of the driver for the actuator, according to the third embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Hereinafter, reference will now be made in detail to examples with reference to the accompanying drawings, wherein like reference numerals refer to like elements throughout.

Various alterations and modifications may be made to the examples. Here, the examples are not construed as limited to the disclosure and should be understood to include all changes, equivalents, and replacements within the idea and the technical scope of the disclosure.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

When an element is referred to as being “on,” “connected to,” “coupled to,” or “adjacent to,” another element, the element may be directly on, connected to, coupled to, or adjacent to, the other element, or one or more other intervening elements may be present.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “include/comprise” and/or “have” when used in this specification, specify the presence of stated features, integers, steps, operations, elements, components, and/or combinations thereof, but do not preclude the presence or addition of one or more other features, numbers, steps, operations, elements, components, and/or groups thereof.

Unless otherwise defined, all terms, including technical terms and scientific terms, used herein have the same meaning as how they are generally understood by those of ordinary skill in the art to which the present disclosure pertains. Any term that is defined in a general dictionary shall be construed to have the same meaning in the context of the relevant art, and, unless otherwise defined explicitly, shall not be interpreted to have an idealistic or excessively formalistic meaning.

Identical or corresponding elements will be given the same reference numerals, regardless of the figure number, and any redundant description of the identical or corresponding elements will not be repeated. Throughout the description of the present disclosure, when describing a certain relevant conventional technology is determined to evade the point of the present disclosure, the pertinent detailed description will be omitted. Terms such as “first” and “second” can be used in describing various elements, but the above elements shall not be restricted to the above terms. The above terms are used only to distinguish one element from the other. In the accompanying drawings, some elements may be exaggerated, omitted or briefly illustrated, and the dimensions of the elements do not necessarily reflect the actual dimensions of these elements.

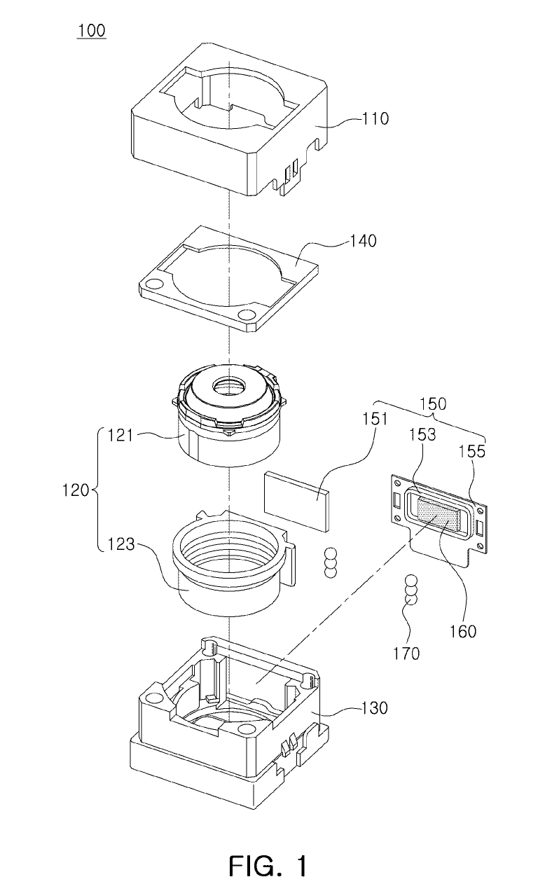

As viewed in FIG. 1, an optical axis direction is defined as a direction perpendicular to an image sensor of the lens module.

FIG. 1 is an exploded perspective view of a camera module, according to a first embodiment.

Referring to FIG. 1, a camera module 100, according to a first embodiment, includes a lens module 120, a stopper 140, a housing 130, an actuator 150, a ball bearing part 170, a shield case 110, and a controlling unit or a controller 160.

The lens module 120 includes a lens barrel 121 and a lens holder 123 accommodating the lens barrel 121.

The lens barrel 121 has a hollow cylindrical shape so that a plurality of lenses photographing an object or a subject are accommodated therein. The lenses are included and arranged in the lens barrel 121 along an optical axis.

A number of the lenses are stacked depending on a design of the lens module 120, and each has optical characteristics, such as the same refractive index or different refractive indices.

In one example, all radii of curvature, thicknesses, optical axis distances from the first surface of the first lens to the image sensor (OALs), a distance on the optical axis between the stop and the image sensor (SLs), image heights (IMGHs), and black focus lengths (BFLs) of the lenses, an overall focal length of an optical system, and a focal length of each lens are indicated in millimeters (mm). Further, thicknesses of lenses, gaps between the lenses, OALs, and SLs are distances measured based on the optical axis of the lenses.

Further, concerning shapes of the lenses, a surface of a lens being convex means that an optical axis portion of a corresponding surface is convex, and a surface of a lens being concave means that an optical axis portion of a corresponding surface is concave. Therefore, in a configuration in which one surface of a lens is convex, an edge portion of the lens may be concave. Likewise, in a configuration in which one surface of a lens is concave, an edge portion of the lens may be convex. In other words, a paraxial region of a lens may be convex, while the remaining portion of the lens outside the paraxial region is either convex, concave, or flat. Further, a paraxial region of a lens may be concave, while the remaining portion of the lens outside the paraxial region is either convex, concave, or flat.

The lens barrel 121 is coupled to the lens holder 123.

For example, the lens barrel 121 is inserted into a hollow provided in the lens holder 123, and the lens barrel 121 and the lens holder 123 may be coupled to each other by a screw coupling manner or may be coupled to each other by an adhesive.

The lens module 120 is accommodated in the housing 130 and moves in an optical axis direction for auto focusing.

To this end, the actuator 150 is provided.

In order to move the lens module 120 in the optical axis direction, the actuator 150 includes a magnet 151 mounted on one side of the lens holder 123 and a coil 153 disposed to face the magnet 151. The coil 153 is mounted on a substrate 155, and the substrate 155 is mounted in the housing 130 so that the coil 153 faces the magnet 151.

The coil 153 moves the lens module 120 along the optical axis direction using electromagnetic force with the magnet 151 adjacent thereto.

That is, the magnet 151 generates a magnetic field, a driving force is generated by electromagnetic force between the magnet 151 and the coil 153 when power is applied to the coil 153, and the lens module 120 moves along the optical axis direction by the driving force.

The controller 160 may include a driver integrated circuit (IC) and a position sensor, and controls an operation of the actuator 150.

The position sensor detects a position of the magnet 151 and consequently detects a position of the lens module 120 in which the magnet 151 is mounted.

The position sensor is disposed at the center of the coil 153, which has a donut shape. In the alternative, the position sensor is disposed at an outer side of the coil 153.

The driver IC and the position sensor may be integrally formed as one element, but are not limited thereto. For example, the driver IC and the position sensor may also be provided as separate elements.

Furthermore, when the lens module 120 is moved in the optical axis direction in the housing 130, the ball bearing part 170 is provided as a guide means to guide the movement of the lens module 120.

The ball bearing part 170 includes one or more ball bearings. In a case in which a plurality of ball bearings are provided, the plurality of ball bearings are disposed along the optical axis direction.

In an example, the ball bearings are disposed to be spaced in a direction perpendicular to the optical axis direction in respect to the magnet 151.

The ball bearing part 170 is in contact with an outer surface of the lens holder 123 and an inner surface of the housing 130 to guide the movement of the lens module 120 in the optical axis direction.

That is, the ball bearing part 170 is disposed between the lens holder 123 and the housing 130, and guides movement of the lens module 120 in the optical axis direction by a cloud motion.

Further, the housing 130 is mounted with the stopper 140, which limits a distance that the lens module 120 is to move.

For example, the stopper 140 is mounted over the housing 130, and the stopper 140 and the lens module 120 are disposed to be spaced apart from each other in the optical axis direction when power is not applied to the coil 153.

Thus, when the lens module 120 is moved in the optical axis direction by applying power to the coil 153, because the distance of movement of the lens module 120 is limited by the stopper 140, the lens module 120 moves within an interval range with the stopper 140.

Further, the stopper 140 is formed of a material having an elastic form so that when the stopper 140 and the lens module 120 come into contact with each other, the stopper 140 exerts an elastic force against the lens module 120 to cushion the impact.

The shield case 110 is coupled to the housing 130 in order to enclose an outer surface of the housing 130, and shields against electromagnetic waves generated when the camera module is driven.

The camera module 100 generates electromagnetic waves when driven. In a case in which the electromagnetic waves are emitted outwardly, the waves may have an effect on other electronic components, causing communications problems or a malfunction of the camera module 100.

According to an embodiment, the shield case 110 is formed of a metallic material, and is grounded to a ground pad of the substrate mounted below the housing 130 to shield against the electromagnetic waves.

Further, in a case in which the shield case 110 is formed of a plastic injection molding material, a conductive paint may be coated on an inner surface of the shield case 110 to shield against the electromagnetic waves.

As the conductive paint, a conductive epoxy is used, but the conductive paint is not limited thereto. For example, various materials having conductivity may be used, and a method of attaching a conductive film or conductive tape onto the inner surface of the shield case 110 may also be used.

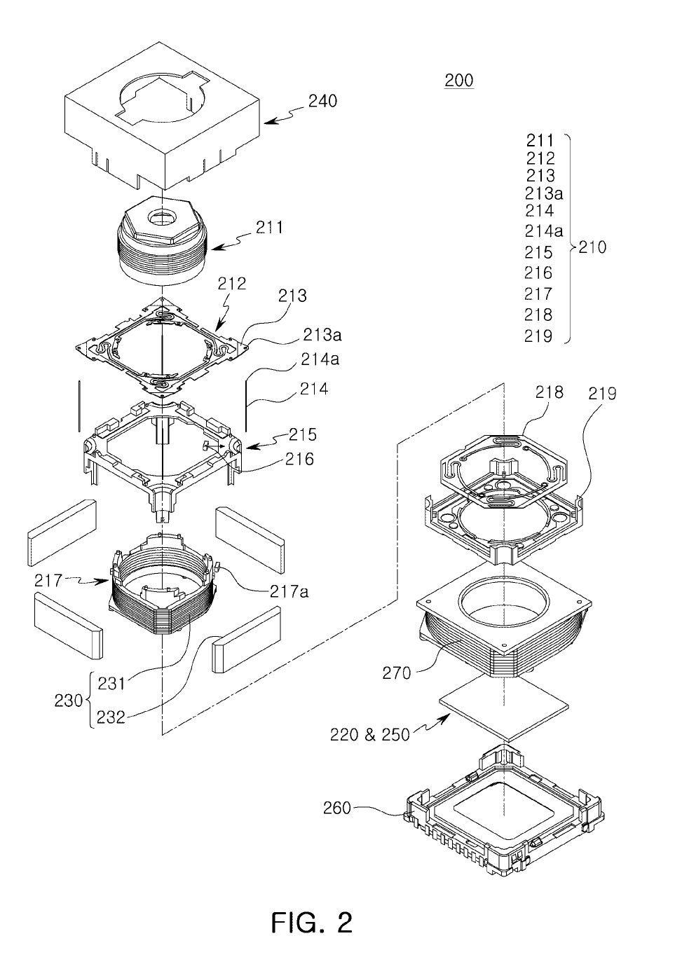

FIG. 2 is an exploded perspective view of a camera module, according to a second embodiment.

Referring to FIG. 2, a camera module 200, according to a second embodiment, includes a lens module 210. The lens module 210 includes a lens barrel 211, and a lens carrier 217, and a shield case 240 coupled to a housing 260. The shield case 240 encloses an outer surface of the housing 130 and shield an electromagnetic wave occurring during the driving of the camera module 200.

A coil 231 is disposed on an outer peripheral surface of the lens carrier 217. The coil 231 is wound on the outer peripheral surface of the lens carrier 217. The coil 231 includes a plurality of wound coils disposed along the outer peripheral surface of the lens carrier 217. A plurality of magnetic bodies 232 are disposed depending on the arrangement of the coil 231. For example, four magnetic bodies 232 are disposed. The coil 231 and the magnetic body 232 form a first actuator 230. A driving force that moves the lens carrier 217 in the optical axis direction is generated by an interaction of an electric field of the coil 231 and a magnetic field of the magnetic body 232. The magnetic body 232 includes first and second magnetic bodies. The first magnetic body and the second magnetic body are formed by polarizing the magnetic body 232. As a result, the movement of the lens carrier 217 is easily controlled.

In addition, for example, at least one of the four magnetic bodies 232 may also be used to provide position information to a hall sensor.

Further, for example, a detection magnetic body 217a is optionally disposed on the lens carrier 217, and may also be disposed on a portion in which the coil 231 is not formed, such as an outer surface of the lens carrier 217.

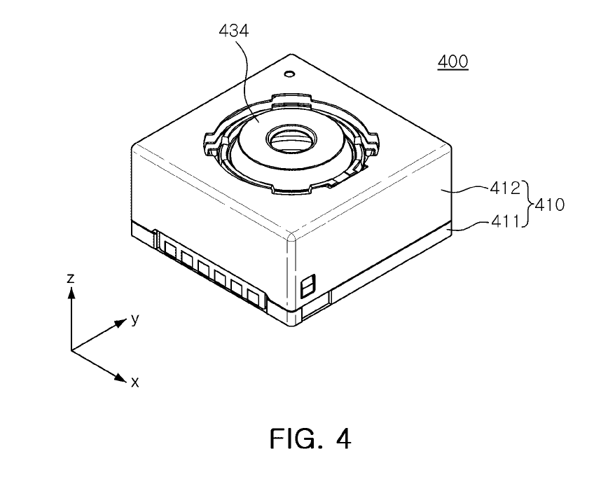

In addition, for example, a hall sensor 216 detecting a magnetic field of the detection magnetic body 217a is optionally disposed on a first frame 215. Further, for example, the hall sensor 216 is a hall sensor 240 illustrated in FIG. 4.

The lens module 210 includes first and second frames 215 and 219 supporting appearance body of the lens module 210, and an elastic member supporting the movement of the lens carrier 217 in the optical axis direction. The elastic member includes a first elastic member 212 and/or a second elastic member 218.

An image sensor module 250 and a driver 220 for an actuator are provided below the second frame 219. In accordance with an embodiment, the image sensor module 250 and the driver 220 for an actuator are configured in one integrated circuit.

A current from the driver 220 for an actuator is transmitted to the coil 231 through a suspension wire 214. To this end, an edge portion 213 of the first elastic member 212 includes a wire coupling portion 213a coupled to one end 214a of the suspension wire 214. The wire coupling portion 213a may have a hall shape.

The first actuator 230 performs an auto focusing (AF) function of the camera module 200.

Further, the camera module 200 further optionally includes a second actuator 270. The second actuator 270 may be operated to perform an optical image stabilization (OIS) function of the camera module 300. A coil is disposed on an outer surface of the second actuator 270, and the coil disposed on the second actuator 270 may share the magnetic body 232 with the coil 231 disposed on the lens carrier 217.

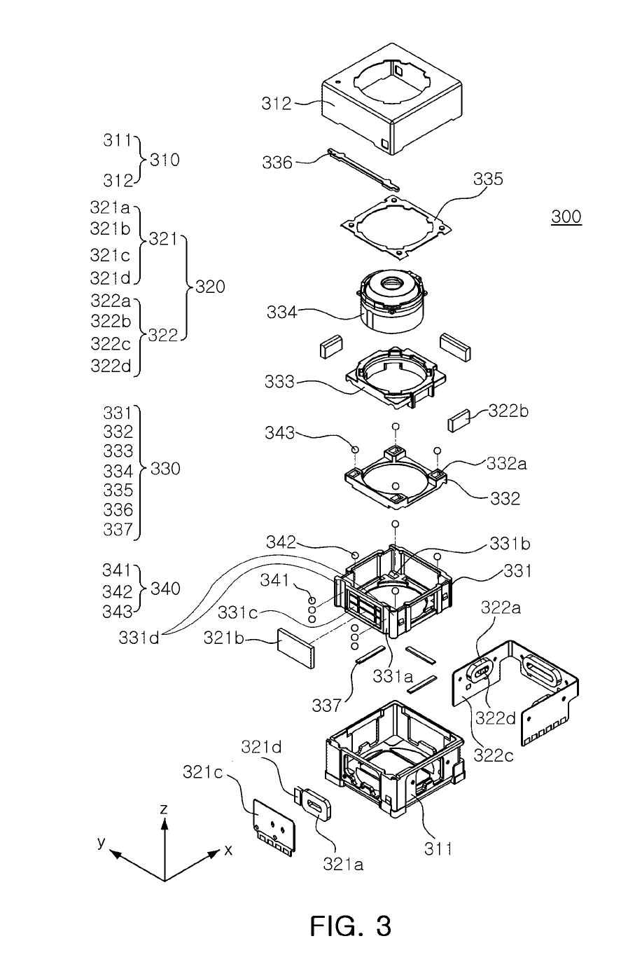

FIG. 3 is an exploded perspective view of a camera module, according to a third embodiment.

Referring to FIG. 3, a camera module 300, according to a third embodiment, includes a housing unit 310, an actuator 320, and a lens module 330.

The housing unit 310 includes a housing 311 and a shield case 312.

The housing 311 is formed of a material that is easy to be shaped. For example, the housing 311 is formed of a plastic material or other polyurethane materials. One or more actuators 320 are mounted on the housing 311. For example, a portion of a first actuator 321 is mounted on a first side surface of the housing 311, and a portion of a second actuator 322 is mounted on second to fourth side surfaces of the housing 311. The housing 311 is configured to accommodate a lens module 330 therein. For example, a storage space fully or partially accommodates the lens module 330 may be formed in the housing 311. The housing 311 has a shape in which six surfaces are opened. For example, a hole of a rectangular shape for an image sensor is formed in a bottom surface of the housing 311, and a hole of a square shape for mounting the lens module 330, as described above, is formed in a top surface of the housing 311. Further, a hole into which a first coil 321a of the first actuator 321 are inserted is formed in the first side surface of the housing 311, and holes into which a second coil 322a of the second actuator 322 are inserted are formed in the second to fourth side surfaces of the housing 311.

The shield case 312 is configured to cover a portion of the housing 311. For example, the shield case 312 is configured to cover a top surface and four side surfaces of the housing 311. However, a shape of the shield case 312 is not limited to a shape of which the shield case 312 fully covers the portions described above. For example, the shield case 312 is configured to cover only the four side surfaces of the housing 311. Alternatively, the shield case 312 is configured to partially cover the top surface and the four side surfaces of the housing 311.

The actuator 320 is configured to move the lens module 330 in one or more directions. For example, the actuator 320 is configured to move the lens module 330 in an optical axis direction (such as a Z axis direction corresponding to a first direction) and directions perpendicular to an optical axis (such as an X axis direction and a Y axis direction corresponding to a second direction and a third direction).

The actuator 320 may be configured to include a plurality of actuators. As an example, the actuator 320 may include the first actuator 321 configured to move the lens module 320 in the Z axis direction, as illustrated in FIG. 3, and the second actuator 322 configured to move the lens module 330 in the X axis direction and the Y axis direction, as illustrated in FIG. 3.

The first actuator 321 is mounted on the housing 311 and a first frame 331 of the lens module 330. For example, a portion of the first actuator 321 is mounted on the first side surface of the housing 311, and the remaining portion of the first actuator 321 is mounted on a first side surface of the first frame 331. The first actuator 321 includes a configuration to move the lens module 330 in the optical axis direction. As an example, the first actuator 321 includes a first coil 321a, a first magnetic body 321b, a first substrate 321c, and a first sensor 321d. The first coil 321a and the first sensor 321d are formed on the first substrate 321c. The first substrate 321c is mounted on the first side surface of the housing 311, and the first magnetic body 321b is mounted on the first side surface of the first fame 331 facing the first substrate 321c.

The first actuator 321, configured as described above, changes magnitude and direction of magnetic force generated between the first coil 321a and the first magnetic body 321b to enable a relative movement of the first frame 331 and a lens barrel 334 to the housing 311. Further, the first actuator 321, configured as described above, senses a position of the first frame 331 using a change in magnetic flux sensed by the first sensor 321d.

The first magnetic body 321b is disposed on one surface 331c of the first frame 331 as illustrated, and may also be disposed on one of corners 331d of the first frame 331.

The second actuator 322 is mounted on the housing 311 and a third frame 333 of the lens module 330. For example, a portion of the second actuator 322 is mounted on the second to fourth side surfaces of the housing 311, and the remaining portion of the second actuator 322 is mounted on second to fourth side surfaces of the third frame 333. The second actuator 322 includes a configuration to move the lens module 330 in the direction perpendicular to the optical axis. As an example, the second actuator 322 includes a plurality of second coils 322a, a plurality of second magnetic bodies 322b, a second substrate 322c, and one or more second sensors 322d. The plurality of second coils 322a and one or more second sensors 322d are formed on the second substrate 322c. The second substrate 322c is formed in substantially a shape of E, and is mounted to surround the second to fourth side surfaces of the housing 311. The plurality of second magnetic bodies 322b are mounted on second to fourth side surfaces of the third frame 333, respectively, so as to face the second substrate 322c.

The second actuator 322, configured as described above, changes magnitude and direction of magnetic force generated between the plurality of second coil 322a and the plurality of second magnetic bodies 322b to enable a relative movement of the second frame 332 or the third frame 333 to the first frame 331. The second frame 332 may be optionally included in the configuration of the camera module 300.

In accordance with an embodiment, the lens barrel 334 moves in the same direction as the second frame 332 or the third frame 333 with the movement of the second frame 332 or the third frame 333. The second actuator 322, configured as described above, detects a position of the second frame 332 or the third frame 333 using a change in magnetic flux sensed by the second sensor 322d.

The lens module 330 is mounted in the housing unit 310. For example, the lens module 330 is accommodated in a storage space formed by the housing 311 and the shield case 312 and moves in at least three-axis directions.

The lens module 330 is configured of a plurality of frames. For example, the lens module 330 includes the first frame 331, the second frame 332, and the third frame 333.

The first frame 331 is configured to be movable to the housing 311. As an example, the first actuator 321 moves the first frame 331 in a height direction of the housing 311 (such as a Z axis direction in FIG. 3). A plurality of guide grooves 331a and 331b are formed in the first frame 331. As an example, a first guide groove 331a extends along the optical direction (such as the Z axis direction in FIG. 3) and is formed in the first side surface of the first frame 331, and a second guide groove 331b extend along in a first direction perpendicular to the optical axis (such as the Y axis direction in FIG. 3). In one illustrative example, the first guide groove 331a and the second guide groove 331b each is formed at four corners of an inner bottom surface of the first frame 331. In another illustrative example, one first guide groove 331a is formed in one corner of the inner bottom surface of the first frame 331 and a second guide groove 331b is formed on each of the four corners of the inner bottom surface of the first frame 331. In a further illustrative example, a first guide groove 331a is formed in each corner of the inner bottom surface of the first frame 331 and a second guide groove 331b is formed on one of the four corners of the inner bottom surface of the first frame 331. The first frame 331 is formed with a shape in which at least three side surfaces thereof are opened. For example, the second to fourth side surfaces of the first frame 331 are opened so that the second magnetic body 322b of the third frame 333 face the second coil 322a of the housing 311.

The second frame 332 is mounted in the first frame 331. For example, the second frame 332 is mounted in an inner space of the first frame 331. The second frame 332 is configured to be moved in the first direction perpendicular to the optical axis to the first frame 331. For example, the second frame 332 moves in the first direction perpendicular to the optical axis (such as the Y axis direction in FIG. 3), along the second guide groove 331b of the first frame 331. A plurality of guide grooves 332a are formed in the second frame 332. For example, four of the guide grooves 332a extend along a second direction perpendicular to the optical axis (such as the X axis direction in FIG. 3) and are formed at corners of the second frame 332.

The third frame 333 is mounted on the second frame 332. For example, the third frame 333 is mounted on a top surface of the second frame 332. The third frame 333 is configured to be moved in the second direction perpendicular to the optical axis to the second frame 332. For example, the third frame 333 moves in the second direction perpendicular to the optical axis (such as the X axis direction in FIG. 3), along a third guide groove 332a of the second frame 332. A plurality of second magnetic bodies 322b are mounted on the third frame 333. For example, at least two of the second permanent magnets 322b are mounted on second to fourth side surfaces of the third frame 333, respectively. In addition, for example, three of the second magnetic bodies 322b are mounted on the second to fourth side surfaces of the third frame 333, respectively.

For example, the second permanent magnets 322b and the second coils 322a control an X axis direction movement of the optical axis of the second frame 332 and a Y axis direction movement of the optical axis of the third frame 333. At least one of the second permanent magnets 322b and at least one of the second coils 322a control the X axis direction movement of the optical axis of the second frame 332, and at least another of the second permanent magnets 322b and at least another of the second coils 322a control the Y axis direction movement of the optical axis of the third frame 333.

In addition, for example, the second magnetic bodies 322b mounted on the third frame 333 and the second coils 322a of the housing 311 face each other on the second and fourth side surfaces of the first frame 331, respectively. For instance, the second magnetic body 322b and the second coil 322a on the second side surface of the first frame 331 face each other, and the second magnetic body 322b and the second coil 322a on the fourth side surface of the first frame 331 face each other to control an X axis direction movement of the optical axis of the second frame 332.

The lens module 330 includes the lens barrel 334. For example, the lens module 330 includes the lens barrel 334 including one or more lenses. The lens barrel 334 is mounted in the third frame 333. For example, the lens barrel 334 is inserted into the third frame 333 to integrally move with the third frame 333. The lens barrel 334 is configured to be moved in the optical axis direction and the direction perpendicular to the optical axis. For example, the first actuator 321 moves the lens barrel 334 in the optical axis direction and the second actuator 322 moves the lens barrel 334 in the direction perpendicular to the optical axis.

In an embodiment, because an air clearance between the second magnetic body 322b of the third frame 333 and the second sensor 322d, formed on the second substrate 322c mounted on the housing 311, changes depending on a movement of the first frame 331 in the optical axis direction, the second sensor 322d may erroneously sense the positions of the second frame 332 and the third frame 333 from actual positions of the second frame 332 and the third frame 333 depending on the movement of the first frame 331.

The error in the positions of the second frame 332 and the third frame 333 sensed by the second sensor 322d depending on the movement of the first frame 331 may cause an intended movement displacement, for example, a moving drift, in the direction perpendicular to the optical axis in order to maintain the lens module 330 at a set position.

As described above, the first actuator 321 is operated to perform the auto focusing (AF) function of the camera module 300, and the second actuator 322 is operated to perform the optical image stabilization (OIS) function of the camera module 300.

Also, the lens module 330 further includes a cover member 335, a ball stopper 336, and a magnetic body 337.

The cover member 335 is configured to prevent a detachment of the second frame 332 and the third frame 333 from the inner space of the first frame 331. For example, the cover member 335 is coupled to the first frame 331 to prevent the second frame 332 and the third frame 331 from being upwardly detached from the first frame 331.

The ball stopper 336 is mounted on the first frame 331. For example, the ball stopper 336 is disposed to cover the first guide groove 331a of the first frame 331 to prevent a detachment of a first ball bearing 341 mounted in the first guide groove 331a.

The magnetic body 337 is mounted on the first frame 331. For example, the magnetic body 337 is mounted on one or more side surfaces of the second to fourth side surfaces of the first frame 331 to generate attraction force with the second coils 322a and the second magnetic bodies 322b of the second actuator 322. The magnetic body 337, configured as described above, affixes the positions of the second frame 332 and the third frame 333 to the first frame 331 in an inactive state of the actuator 320. For example, the lens module 330 is maintained at a constant position within the housing 331 by the attraction force between the magnetic body 337 and the second coil 322a.

A ball bearing part 340 is configured to smoothly move the lens module 330. For example, the ball bearing part 340 is configured to smoothly move the lens module 330 in the optical axis direction and the direction perpendicular to the optical axis. The ball bearing part 340 includes a first ball bearing 341, a second ball bearing 342, and a third ball bearing 343. As an example, the first ball bearing 341 is disposed in the first guide groove 331a of the first frame 331 to smoothly move the first frame 331 in the optical axis direction. As another example, the second ball bearing 342 is disposed in the second guide groove 331b of the first frame 331 to smoothly move the second frame 332 in the first direction perpendicular to the optical axis. As another example, the third ball bearing 343 is disposed in the third guide groove 332a of the second frame 332 to smoothly move the third frame 333 in the second direction perpendicular to the optical axis.

For example, each of the first and second ball bearings 341 and 342 includes at least three balls, and the at least three balls of each ball bearing 341 and 342 are each disposed in the first or second guide groove 331a or 331b. Further, each of the first and second ball bearings 341 and 342 includes four balls, and each of the four balls of each ball bearing is disposed in the first or second guide groove 331a or 331b.

For reference, although not illustrated in the drawings, all of the portions in which the ball bearing part 340 is disposed may be filled with a lubricating material or fluid to reduce friction and noise. For example, a viscous fluid is injected into the respective guide grooves 331a, 331b, and 332a. As the viscous fluid, grease having excellent viscosity and lubrication characteristic may be used.

FIG. 4 is a coupled perspective view of the camera module according to each of the first to third embodiments illustrated in FIGS. 1 through 3.

A camera module 400 has an auto focusing function and an image stabilization function. For example, a lens barrel 434 moves in each of the optical axis direction and the direction perpendicular to the optical axis within a housing unit 410. Therefore, the camera module 400, according to an embodiment, is easily miniaturized and thinned.

Although not illustrated in FIG. 4, the camera module 400, according to an embodiment, includes a driver for an actuator to control the actuator.

The driver for an actuator is implemented as a part of a driver integrated circuit (IC), and outputs a control signal for driving the actuator in response to instructions directed by an application integrated circuit (IC) mounted on an electronic device including the camera module 400.

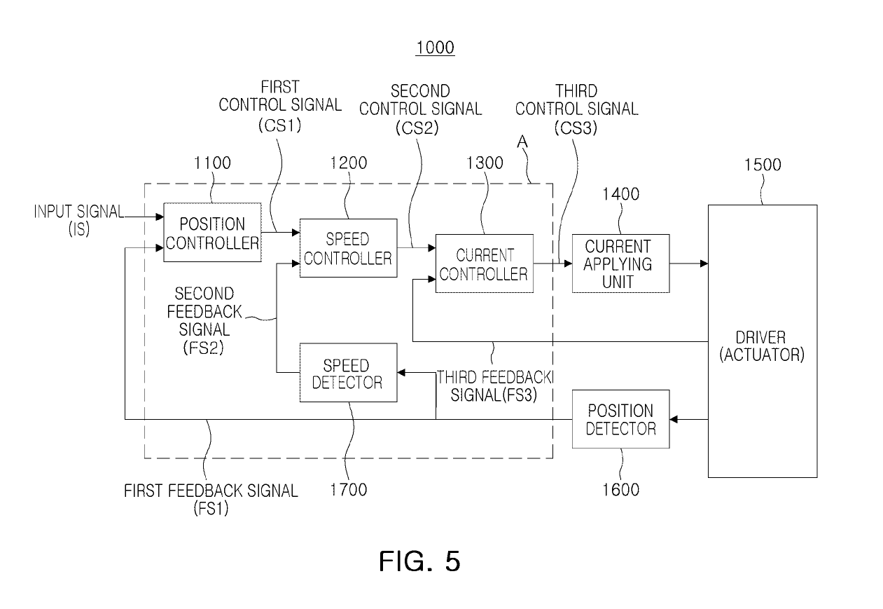

FIG. 5 is a block diagram of a driver for an actuator, according to a first embodiment.

Referring to FIG. 5, a driver 1000 for an actuator, according to a first embodiment, include a position controller 1100, a speed controller 1200, a current controller 1300, a current applying unit 1400, a driver (actuator) 1500, a position detector 1600, and a speed detector 1700. The position controller 1100, the speed controller 1200, the current controller 1300, and the speed detector 1700 are included in a controller A.

The driver for an actuator, according to the first embodiment, controls driving when the camera module (hereinafter, being described with reference to FIG. 1) described with reference to FIGS. 1 through 4 is auto focused or image-stabilized, the controller (the driver IC) 160 performs a control operation of the camera module described with reference to FIG. 1, and a control method may be a proportional integral derivative (PID) method.

First, when an input signal IS, indicative of a target position of the lens module 120 (FIG. 1), and a first feedback signal FS1, indicative of a current position of the lens module 120 (FIG. 1), are input to the position controller 1100, the position controller 1100 sets a distance that the lens module 120 needs to be moved, in response to the input signal IS and the first feedback signal FS1.

When the distance that the lens module 120 needs to be moved is set, information, such as a first control signal CS1, about the distance that the lens module 120 (FIG. 1) needs to be moved is transmitted to the speed controller 1200.

When the first control signal CS1 and a second feedback signal FS2, which is a current moving speed of the lens module 120, are input to the speed controller 1200, the speed controller 1200 sets or defines a speed or how quickly to move the lens module 120 (FIG. 1) to the target position, that is, the target speed of the lens module 120 (FIG. 1).

The speed controller 1200 presets a time necessary to complete a movement of the lens module 120 (FIG. 1) depending on a distance that the lens module 120 is to move (FIG. 1), and consequently sets the target speed of the lens module 120 (FIG. 1).

When the target speed of the lens module 120 (FIG. 1) is set, information, including a second control signal CS2, on the target speed of the lens module 120 (FIG. 1) is transmitted to the current controller 1300.

The second control signal CS2 also includes the first control signal CS1, which is the information about the distance that the lens module 120 (FIG. 1) needs to be moved.

The speed controller 1200 presets the time needed to complete the movement of the lens module 120 (FIG. 1) depending on the distance of movement of the lens module 120 (FIG. 1). The speed controller 1200 presets the time because if information regarding movement time and information regarding the target speed are known, information regarding a distance of movement may also be known.

When the second control signal CS2 and a third feedback signal FS3, which is a most current value applied to the driver 1500, are input to the current controller 1300, the current controller 1300 sets a current value to be applied to the driver 1500 in relation to the second control signal CS2 and the third feedback signal FS3.

When the current value or an amount of current needed to be applied to the driver 1500 is set, information (such as a third control signal CS3) regarding the current value or the amount of the current needed to be applied to the driver 1500 is transmitted to the current applying unit 1400.

When the third control signal CS3 is input to the current applying unit 1400, the current applying unit 1400 generates and applies a current to the driver 1500. As a result, the driver 1500 is operated, and the lens module 120 (FIG. 1) moves up to the target position by the operation of the driver 1500.

Furthermore, the position detector 1600 detects a current position of the lens module 120 (FIG. 1), and transfers the current position of the lens module 120 to the position controller 1100 and the speed detector 1700. The speed detector 1700 calculates current speed of the lens module 120 (FIG. 1) based on information regarding the current position of the lens module 120 (FIG. 1), and transfers the calculated current speed of the lens module 120 to the speed controller 1200.

Because the driver for an actuator, according to the first embodiment, uses the speed information of the lens module 120 (FIG. 1) as well as the position information of the lens module 120 (FIG. 1) for a control operation, control performance (such as, a time taken to arrive at the target position) is improved.

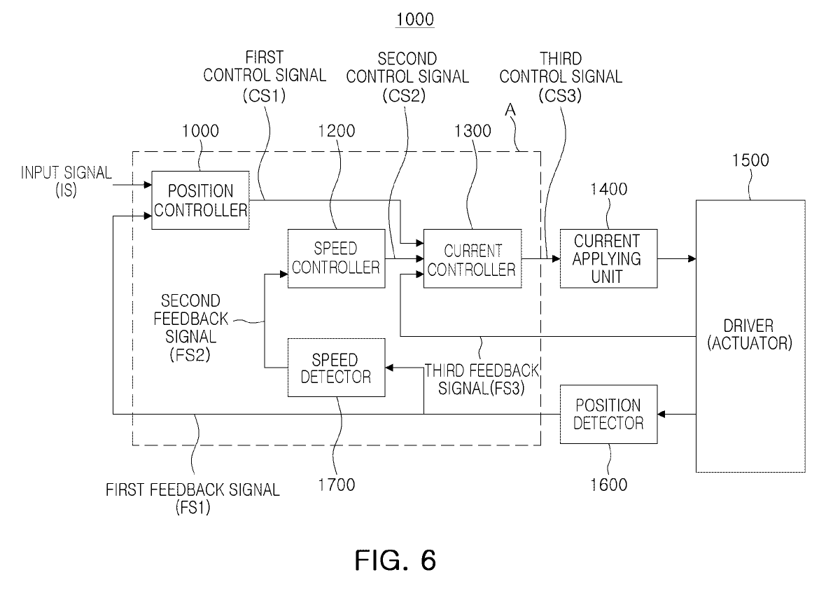

FIG. 6 is a block diagram of a driver for an actuator, according to a second embodiment.

Referring to FIG. 6, unlike the driver 1500 for an actuator, according to the first embodiment described above, a driver 1500 for an actuator, according to a second embodiment, transfers the first control signal CS1 from the position controller 1100 to the current controller 1300.

First, when an input signal IS (a target position of the lens module 120 (FIG. 1)) and a first feedback signal FS1 (a current position of the lens module 120 (FIG. 1)) are input to the position controller 1100, the position controller 1100 sets a distance that the lens module 120 (FIG. 1) needs to be moved, in response to the input signal IS and the first feedback signal FS1.

When the distance that the lens module 120 (FIG. 1) needs to be moved is set, information (a first control signal CS1) on a distance that the lens module 120 (FIG. 1) needs to be moved is transmitted to the current controller 1300.

When a second feedback signal FS2 (current moving speed of the lens module 120 (FIG. 1)) is input to the speed controller 1200, the speed controller 1200 sets or defines how quickly to move the lens module 120 (FIG. 1) to the target position, that is, the target speed of the lens module 120 (FIG. 1).

The speed controller 200 presets a time necessary up to a completion of movement of the lens module 120 (FIG. 1), regardless of a distance that the lens module 120 is to move (FIG. 1), and, consequently, sets the target speed of the lens module 120 (FIG. 1).

When the target speed of the lens module 120 (FIG. 1) is set, information (a second control signal CS2) on the target speed of the lens module 120 (FIG. 1) is transmitted to the current controller 1300.

When the first control signal CS1, the second control signal CS2, and a third feedback signal FS3 (a current value applied to the driver 1500) are input to the current controller 1300, the current controller 1300 sets a current value needed to be applied to the driver 1500 in respect to the first control signal CS1, the second control signal CS2, and the third feedback signal FS3.

When the current value needed to be applied to the driver 1500 is set, information (a third control signal CS3) on the current value needed to be applied to the driver 1500 is transmitted to the current applying unit 1400.

When the third control signal CS3 is input to the current applying unit 1400, the current applying unit 1400 applies a current to the driver 1500, in response to the third control signal CS3. As a result, the driver 1500 is operated, and the driver 1500 moves the lens module 120 (FIG. 1) up to the target position.

Furthermore, the position detector 1600 detects a current position of the lens module 120 (FIG. 1), and transfers the current position of the lens module 120 to the position controller 1100 and the speed detector 1700. The speed detector 1700 calculates current speed of the lens module 120 (FIG. 1) based on information regarding the current position of the lens module 120 (FIG. 1), and transfers the calculated current speed of the lens module 120 to the speed controller 1200.

Because the driver for an actuator 1500, according to the second embodiment, uses the speed information of the lens module 120 (FIG. 1) and the position information of the lens module 120 (FIG. 1) for a control operation, control performance (e.g., a time taken to arrive at the target position) is improved.

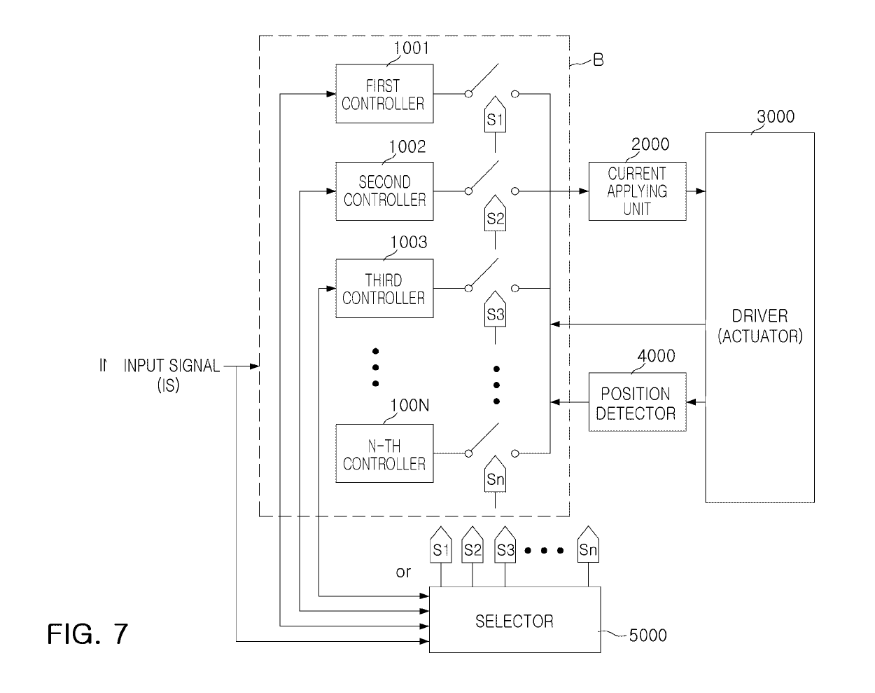

FIG. 7 is a block diagram of a driver for an actuator, according to a third embodiment.

Referring to FIG. 7, in a driver 3000 for an actuator, according to a third embodiment, the controller 160 (FIG. 1, driver IC) includes one or more controllers B. Each of the one or more controllers B may be any one of the controllers of the driver 1500 for an actuator according to the first embodiment and the driver 1500 for an actuator according to the second embodiment described above.

In a case in which only one controller is included in the controller 160 (FIG. 1, driver IC), there may be a problem in that the control performance (such as, the time taken to arrive at the target position, how closely the lens module 120 (FIG. 1) may arrive at the target position, etc.) is to be changed depending on the distance of movement, which is a difference between an initial position of the lens module 120 (FIG. 1) and the target position thereof, that the lens module 120 (FIG. 1) is moved by an operation of the actuator during an auto focusing process.

Because the lens module 120 (FIG. 1) is moved while in contact with the ball bearing part 170 (FIG. 1), the control performance may be changed by friction force, such as static friction force and kinetic friction force, between the lens module 120 (FIG. 1) and the ball bearing part 170 (FIG. 1).

For example, when the lens module 120 (FIG. 1) is moved from a static state to the target position, in a case in which the target position is relatively close, the static friction force may have a great impact on movement characteristics of the lens module 120 (FIG. 1).

However, when the lens module 120 (FIG. 1) is moved from a static state to the target position, in a case in which the target position is relatively distant, the kinetic friction force may have a great impact on movement characteristics of the lens module 120 (FIG. 1).

That is, in a case in which the movement of the lens module 120 (FIG. 1) is controlled by one controller, because of the influence of the static friction force and the kinetic friction force on movement characteristics of the lens module 120 (FIG. 1) changes depending on the distance of movement of the lens module 120 (FIG. 1), it may be difficult to implement desired performance.

Thus, in the driver for an actuator, according to the third embodiment, the controller 160 (FIG. 1, driver IC) may include the plurality of controllers.

The plurality of controllers 1001 to 100N, each perform a control of the PID method, and control parameters that are each set in the controllers 1001 to 100N are configured, defined, or set to be different from each other.

A selector 5000 of the driver 3000 of an actuator, according to an embodiment, selects any one of the controllers 1001 to 100N based on various parameters, and performs a control operation.

In accordance with an embodiment, a configuration and an operation of each of the controllers 1001 to 100N, and the operations of a current applying unit 2000, a driver 3000, and a position detector 4000 is the same as the description of FIGS. 3 and 4 described above.

For example, the selector 5000 performs a control operation so that only a corresponding controller among the controllers is operated, and performs a control operation so that operations of the remaining controllers are stopped. Alternatively, the selector 5000 connects or disconnects signal transfer paths between the controllers and the current applying unit 2000 so that an output signal of the corresponding controller, among output signals that are output by operating each of the plurality of controllers, is transmitted to the current applying unit 2000 (reference numerals S1, S2, S3, and Sn).

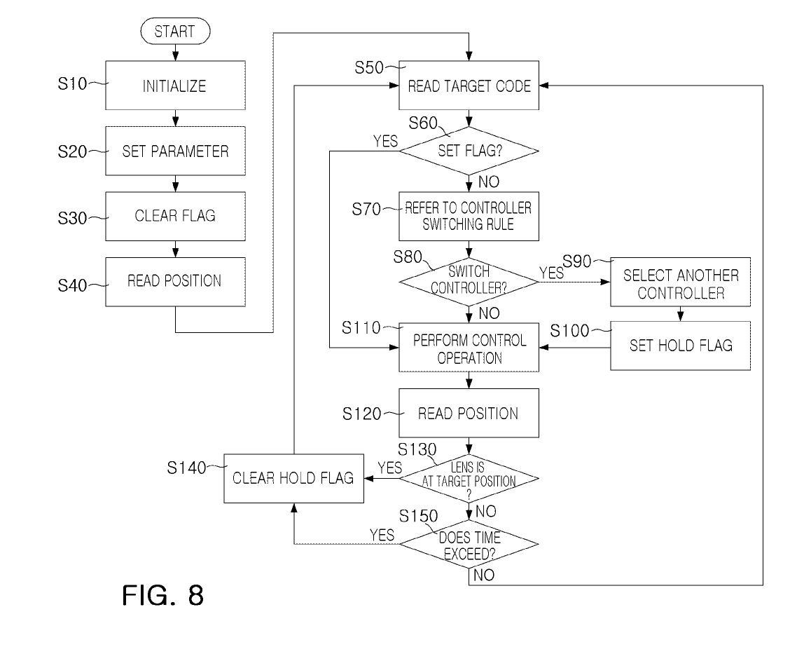

FIG. 8 is an operation flow chart of the driver for an actuator, according to the third embodiment illustrated in FIG. 7.

Referring to FIGS. 7 and 8, at operation S10, the driver for an actuator, according to the third embodiment, performs an initialization. At operation S20, each of the controllers 1001 to 100N configures, defines, or sets a parameter and, at operation S30, the driver clears a flag. At operation S40, each of the controllers 1001 to 100N reads a position of a lens, at operation S50, reads a target code instructing of a target position, and, at operation S60, confirms whether or not the flag is set.

If the flag is not set, at operation S70, each of the controllers 1001 to 100N refers to a controller switching rule. At operation S80, if the controller is switched, at operation S90, another corresponding controller 1001 to 100N is selected. At operation S100, each of the controllers 1001 to 100N sets a hold flag to prevent controller switching from being performed during a control operation.

At operation S110, the selected controller 1001 to 100N performs an auto focusing control operation, at operation S120, reads the position of the lens, and, at operation S130, confirms whether or not the lens is at the target position. If the lens is present at the target position, at operation S140, the selected controller 1001 to 100N clears the hold flag (S140) and, returns to operation S50 to read the target code.

If the lens is not at the target position, at operation S150, the selected controller confirms whether a time period has been exceeded. In response to the time period being exceeded and the lens being present at the target position, at operation S140, the selected controller 1001 to 100N clears the hold flag and, at operation S50, reads the target code. In response to the time period not being exceeded, at operation S50, the selected controller 1001 to 100N reads the target code.

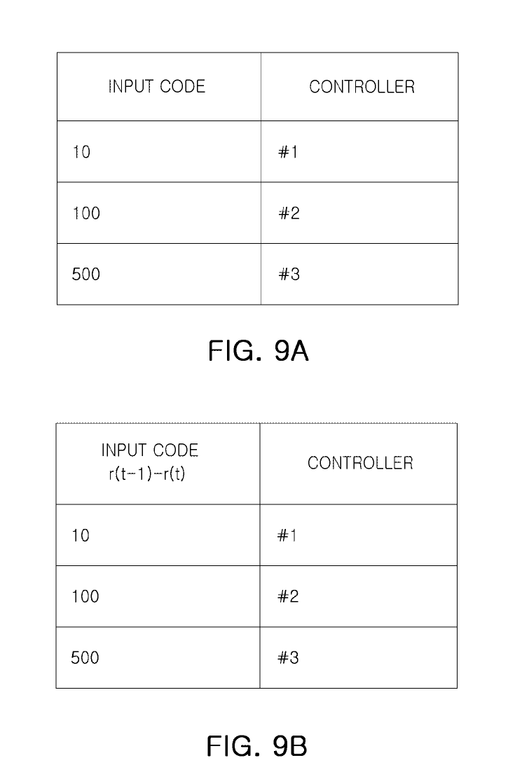

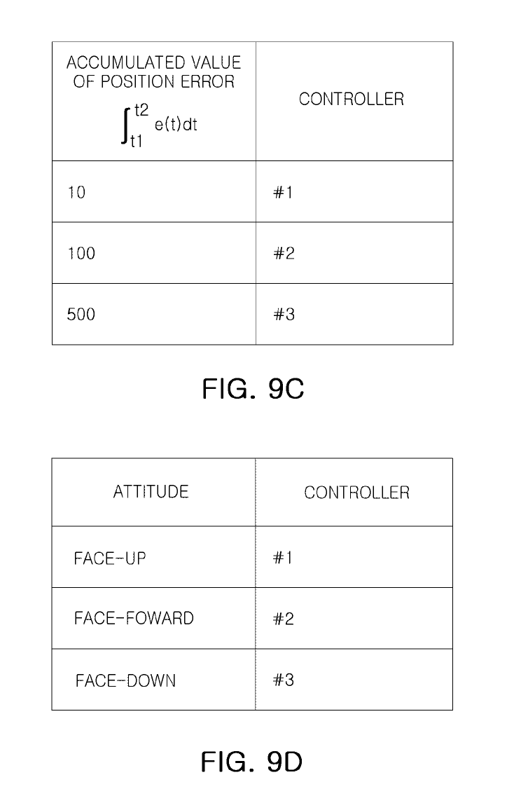

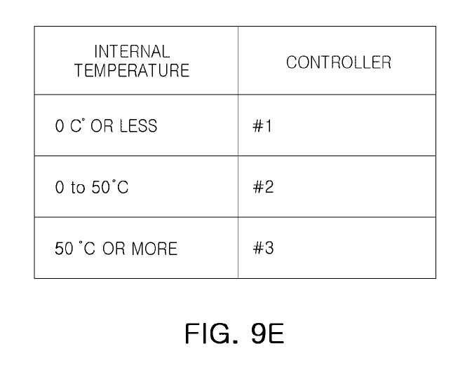

FIGS. 9A through 9E are tables illustrating a controller selection depending on parameters of the driver for an actuator, according to the third embodiment.

Referring to FIGS. 7, 8, and 9A through 9E, if the flag is not set, the selector 500 switches a controller that is currently being operated with another controller with reference to the controller switching rule.

Referring to FIG. 9A, the selector 500 selects the controller based on the input code (target code) to select the controller. For example, in a case in which a degree of motion of the lens module is 0 to 1000, in response to information included in the input code being information indicating that the lens module is moved by a degree of 10, the selector 500 selects a first controller #1. In response to the information included in the input code being information indicating that the lens module is moved by a degree of 100, the selector 500 selects a second controller #2. In response to the information included in the input code being information indicating that the lens module is moved by a degree of 500, the selector 500 selects a third controller #3.

Referring to FIG. 9B, the selector 500 selects the controller based on the input code (target code) to select the controller and selects the controller based on a difference between a current value of the input code and an immediately previous value thereof. For example, in response to the degree of motion of the lens module being 0 to 1000, when a difference between information included in a current input code and information included in an immediately previous input code corresponds to a difference of motion of a degree of 10 of the lens module, the selector 500 selects the first controller #1. Also, in response to the difference between the information included in the current input code and the information included in the immediately previous input code corresponding to a difference of motion of a degree of 100 of the lens module, the selector 500 selects the second controller #2. In response to the difference between the information included in the current input code and the information included in the immediately previous input code corresponding to a difference of motion of a degree of 500 of the lens module, the selector 500 selects the third controller #3.

Furthermore, for example, in response to a distance, which is a difference between an initial position and the target position, that the lens module 120 (FIG. 1) is moved being within a reference range, the first controller #1 of the controllers 1001 to 100N is selected; in response to the distance that the lens module 120 (FIG. 1) being moved is smaller than the reference range, the second controller #2 of the plurality of controllers is selected; and in response to the distance that the lens module 120 (FIG. 1) is moved being larger than the reference range, the third controller #3 of the plurality of controllers is selected.

Furthermore, referring to FIG. 9C, in accordance with an embodiment, a reference selecting any one of the controllers may also be the target position indicated by the information included in the input code of the lens module 120 (FIG. 1), and an error, which is a difference between the current position of the lens module 120 (FIG. 1) and the target position thereof, is sensed in real time to use an accumulated value of the error as the reference.

For example, when the accumulated value of the error is 1, the first controller #1 is selected; when the accumulated value of the error is 10, the second controller #2 is selected; and when the accumulated value of the error is 100, the third controller #3 is selected.

Further, referring to FIG. 9D, any one of the controllers may be selected depending on an application, an attitude, a configuration, or a performance of the camera module or an electronic device including the camera module.

For example, when the attitude of the camera module is a face-up attitude, the first controller #1 is selected, when the attitude of the camera module is a face-forward attitude, the second controller #2 is selected, and when the attitude of the camera module is a face-down attitude, the third controller #3 is selected.

Furthermore, although not illustrated, the driver for an actuator or the electronic device may further include an accelerator sensor or a gyro sensor to recognize the attitude of the camera module described above, and may further include a communications interface such as I2C or SPI, that may receive information regarding the recognized attitude and a storage element such as a register or a memory in which information regarding the attitude may be stored.

In addition, referring to FIG. 9E, any one of the may be selected depending on a temperature of the camera module.

For example, when an internal temperature of the camera module is 0° C. or less, the first controller #1 is selected; when the internal temperature of the camera module is 0° C. to 50 CC, the second controller #2 is selected; and when the internal temperature of the camera module is 50° C. or more, the third controller #3 is selected.

Although not illustrated, the driver for an actuator or the electronic device including the same may further include a temperature sensor to sense the internal temperature of the camera module described above, and the driver for an actuator may also autonomously perform a temperature measurement function.

Although one or more embodiments describes one or more examples in which three controllers in the plurality of controllers are used, the number of controllers is not limited, and the controller may be N (N is a natural number of 1 or larger) controllers.

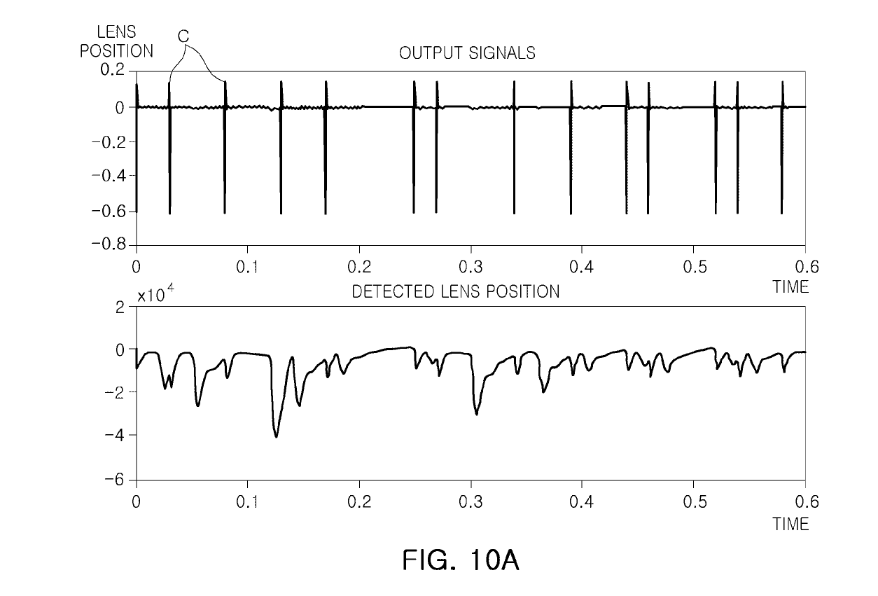

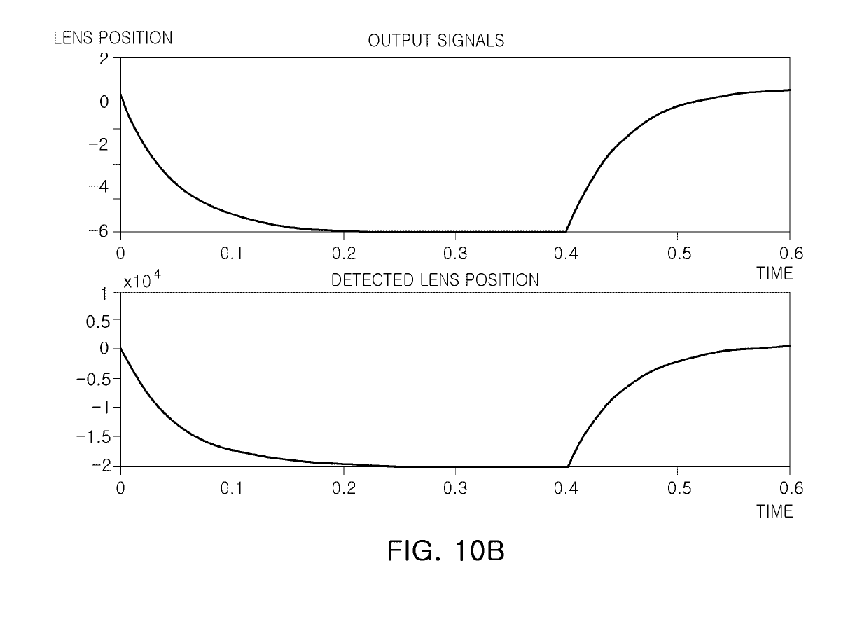

FIG. 10A is a graph illustrating a controller output signal and a lens position of a general driver for an actuator, and FIG. 10B is a graph illustrating a controller output signal and a lens position of the driver for an actuator, according to the third embodiment.

Referring to FIG. 10A, in an example of the general driver for an actuator, when the controller is changed during a process in which the lens module is moved to the target position, because the controller is changed, for instance, the controller is changed twice during 0.1 seconds as indicated by reference numeral C, before the position of the lens module is stabilized, there is a problem in that the position of the lens module is not stabilized.

Conversely, referring to FIG. 10B, in the driver for an actuator according to the third embodiment, it may be seen that because the controller is changed after the position of the lens module is stably controlled, the position of the lens module is stabilized. For example, as illustrated in the graph, the input code is changed once at 0.4 seconds and the controller is selected at the same time; as a result, the lens module is stably moved to the target position.

As set forth above, according to the embodiments, the driver for an actuator improve the response speed during the auto focusing or image stabilization process of the camera module.

Further, the driver for a camera module may prevent control performance from being changed in the auto focusing or image stabilization process.

The drivers, driver integrated circuit, apparatuses, units, modules, devices, and other components illustrated in FIGS. 1-5 that perform the operations described herein with respect to FIGS. 6-8 are implemented by hardware components. Examples of hardware components include controllers, sensors, generators, drivers, and any other electronic components known to one of ordinary skill in the art. In one example, the hardware components are implemented by one or more processors or computers, a central processing unit (CPU), a microprocessor, an application specific integrated circuit (ASIC), field programmable gate arrays (FPGA), and the like, and may have a plurality of cores. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. *. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 6-8 that perform the operations described herein with respect to FIGS. 1-5 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A driver, comprising:
a position detector configured to detect a position of a lens module;
a controller configured to control movement of the lens module based on information on a target position of the lens module included in an input signal and speed information generated based on the position of the lens module detected by the position detector;
a current applying unit configured to apply a current to move the lens module according to a control of the controller; and
a driver actuator configured to drive the lens module according to the current from the current applying unit.

2. The driver of claim 1, wherein the controller is further configured to
generate a first control signal based on the information on the target position,
generate a second control signal based on the speed information, and
control the current generated in response to the first control signal, or the first control signal and the second control signal.

3. The driver of claim 2, wherein the controller comprises
a position controller configured to generate the first control signal according to the information on the target position;
a speed detector configured to detect movement speed of the lens module using the position detected by the position detector and generate the speed information;
a speed controller configured to generate the second control signal according to the first control signal and the speed information; and
a current controller configured to control the current generated based on the second control signal.

4. The driver of claim 2, wherein the controller includes
a position controller configured to generate the first control signal according to the information on the target position;
a speed detector configured to detect movement speed of the lens module using the position detected and generate the speed information;
a speed controller configured to generate the second control signal according to the speed information; and
a current controller configured to control an amount of the current generated based on the first control signal and the second control signal.

5. A driver, comprising:
controllers having different control characteristics to control a lens module; and
a selector configured to select one of the controllers to control the movement of the lens module based on information about a target position of the lens module included in an input signal, and speed information generated based on a position of the lens module.

6. The driver of claim 5, wherein the selector selects one of the controllers based on one of a target position of the lens module, an attitude of a camera module, and an internal temperature of the camera module.

7. The driver of claim 6, wherein the selector selects one of the controllers based on one of a distance of movement up to the target position of the lens module, a difference of a distance between a previous position of the lens module and the target position thereof, an accumulated value of error between the target position of the lens module and an actual position thereof, the attitude of the camera module, and the internal temperature of the camera module.

8. The driver of claim 7, wherein the selector sets a hold flag to prevent a switching of the selection from a currently selected controller to another controller.

9. The driver of claim 5, further comprising:
a current applying unit configured to apply a current to move the lens module based on a control of the one of the controllers;
a driver configured to receive the current to drive the lens module; and
a position detector configured to detect the position of the lens module.

10. The driver of claim 9, wherein the controller generates a first control signal based on the information on the target position, generates a second control signal based on the speed information, and controls the current generated by the current applying unit in response to the first control signal or the first control signal and the second control signal.

11. The driver of claim 10, wherein the controller comprises
a position controller configured to generate the first control signal according to the information on the target position;
a speed detector configured to detect movement speed of the lens module using the detected position and generate the speed information;
a speed controller configured to generate the second control signal based on the first control signal and the speed information; and
a current controller configured to control an amount of the current generated based on the second control signal.

12. The driver of claim 10, wherein the controller comprises
a position controller configured to generate the first control signal based on the information on the target position;
a speed detector configured to detect movement speed of the lens module using the position of the lens module and generate the speed information;
a speed controller configured to generate the second control signal based on the speed information; and
a current controller configured to control an amount of the current generated by the current applying unit based on the first control signal and the second control signal.

13. A camera module, comprising:
an actuator configured to move a lens module; and
a driver configured to generate a current to drive the actuator based on information on a target position of the lens module included in an input signal and speed information generated based on a detected position of the lens module.

14. The camera module of claim 13, wherein the driver for an actuator includes
a controller configured to control a movement of the lens module based on the information on the target position and the speed information;
a current applying unit configured to apply a current to move the lens module based on the control from the controller; and
a position detector configured to detect a position of the lens module.

15. The camera module of claim 14, wherein the controller is configured to generate a first control signal based on the information on the target position, generate a second control signal based on the speed information, and control the current generated by the current applying unit in response to the first control signal or the first control signal and the second control signal.

16. The camera module of claim 15, wherein the controller includes
a position controller configured to generate the first control signal according to the information on the target position;
a speed detector configured to detect movement speed of the lens module using the detected position and generate the speed information;
a speed controller configured to generate the second control signal based on the first control signal and the speed information; and
a current controller configured to control an amount of the current generated based on the second control signal.

17. The camera module of claim 15, wherein the controller includes
a position controller configured to generate the first control signal according to the information on the target position;
a speed detector configured to detect a movement speed of the lens module using the detected position and generate the speed information;
a speed controller configured to generate the second control signal according to the speed information; and
a current controller to control an amount of the current generated based on the first control signal and the second control signal.

18. The camera module of claim 13, wherein the driver for an actuator comprises
controllers having different control characteristics for controlling a lens module; and
a selector configured to select one of the controllers to control a movement of the lens module based on information about a target position of the lens module included in an input signal, and speed information generated based on a detected position of the lens module.

19. The camera module of claim 18, wherein the selector selects one of the controllers based on one of a target position of the lens module, an attitude of a camera module, and an internal temperature of the camera module.

20. The camera module of claim 19, wherein the selector selects one of the controllers based on one of a distance of movement up to the target position of the lens module, a difference of a distance between a previous position of the lens module and the target position thereof, an accumulated value of error between the target position of the lens module and an actual position thereof, the attitude of the camera module, and the internal temperature of the camera module.

21. The camera module of claim 20, wherein the selector sets a hold flag to prevent a switching of the selection from a currently selected controller to another controller.

22. The camera module of claim 13, wherein the actuator comprises
a coil configured to generate a magnetic field according to the current; and
a magnetic body configured to interact with the magnetic field to generate a driving force moving the lens module.

23. The camera module of claim 22, further comprising:
a magnetic body configured to detect a strength of the magnetic field, and comprises a first magnetic body and a second magnetic body, which are polarized.

24. The camera module of claim 13, further comprising:
a substrate onto which the driver for the actuator is mounted,
wherein the actuator comprises
a coil disposed on the substrate and configured to generate a magnetic field according to the current; and
a magnetic body disposed to face the coil and configured to interact with the current of the coil to generate a driving force moving the lens module.

25. The camera module of claim 22, wherein magnetic bodies are disposed in accord with an arrangement of the coil.

26. The camera module of claim 24, further comprising:
an elastic member disposed on at least one of an upper portion or a lower portion of the lens module to support movement of the lens module.

27. The camera module of claim 26, further comprising:
a suspension wire configured to transfer the current from the driver for an actuator to the coil.

28. The camera module of claim 13, wherein the actuator comprises
a first actuator configured to perform an auto focusing (AF) function; and
a second actuator configured to perform an optical image stabilization (OIS) function.

29. The camera module of claim 28, wherein the lens module comprises at least one of a first frame, a second frame, and a third frame which support an appearance body thereof, and
each of the first and second actuators comprises a coil and a magnetic body.

30. The camera module of claim 29, wherein the first actuator further comprises a first substrate onto which the coil is disposed, and
the magnetic body of the first actuator is disposed on one of one surface or a corner of a first frame.

31. The camera module of claim 28, wherein the second actuator comprises
an X axis coil mounted on an inner surface of a second substrate having a shape of C to move a lens barrel of the lens module in one direction perpendicular to an optical axis; and
a Y axis coil mounted on the inner surface of the second substrate to move the lens barrel of the lens module in the other direction which is perpendicular to the optical axis and is perpendicular to the one direction

32. The camera module of claim 31, wherein the second actuator comprises two X axis coils, each disposed on two surfaces opposite to each other of the inner surface of the second substrate.

33. The camera module of claim 29, further comprising:
ball bearings smoothly moving the lens module along an optical axis direction and a direction perpendicular to the optical axis,
wherein each of the ball bearings is disposed on at least three corners of a first frame or a second frame.

34. A driver, comprising:
a position controller configured to define a distance that a lens module is to move based on a target position of the lens module and a current position of the lens module, and output a first control signal indicative thereof;
a speed controller configured to receive the first control signal and a current moving speed of the lens module to set a target speed to move the lens module to the target position, and output a second control signal indicative thereof;
a current controller configured to set a current based on the second control signal; and
a current applying unit configured to apply the current to an actuator to move the lens module up to the target position.

35. The driver of claim 34, wherein the target speed is based on a time to complete a movement of the lens module and the distance that the lens module is to move.

36. The driver of claim 34, further comprising:
a position detector configured to detect the current position of the lens module, and transmit the current position of the lens module to the position controller and the speed detector.

37. The driver of claim 34, further comprising:
a speed detector configured to calculate the current moving speed of the lens module based on information regarding the current position of the lens module, and transmit the calculated current speed of the lens module to the speed controller.

38. A method for a driver, comprising:
defining, at a position controller, a distance that a lens module is to move based on a target position of the lens module and a current position of the lens module, and output a first control signal indicative thereof;
receiving, at a speed controller, the first control signal and a current moving speed of the lens module to set a target speed to move the lens module to the target position, and output a second control signal indicative thereof;
setting, at a current controller, a current based on the second control signal; and
applying, at a current applying unit, the current to an actuator to move the lens module up to the target position.

39. The method of claim 38, further comprising:
controlling an amount of the current based on the first control signal and the second control signal.

40. The method of claim 38, further comprising:
generating a magnetic field according to the current; and
generating a driving force to move the lens module based on the magnetic field.

41. The method of claim 38, further comprising:
calculating the current speed of the lens module based on information regarding the current position of the lens module.
